(19) United States
(12) Patent Application Publication
(10) Pub. No.: US 2018/0192448 A1
(43) Pub. Date: Jul. 5, 2018

(54) METHOD, DEVICE, AND SYSTEM FOR AUDIO BLUETOOTH PAIRING AND CONNECTING

(71) Applicant: UBTECH Robotics Corp., Shenzhen (CN)

(72) Inventors: Youjun Xiong, Shenzhen (CN); Wei He, Shenzhen (CN)

(21) Appl. No.: 15/605,870

(22) Filed: May 25, 2017

(30) Foreign Application Priority Data
Dec. 31, 2016 (CN) 201611264335.X

(51) Int. Cl. H04W 76/02; H04W 4/00

(52) U.S. Cl. CPC H04W 76/023; H04W 76/021; H04W 4/008

(57) ABSTRACT

An audio Bluetooth pairing and connecting method is provided. The method includes: connecting a main controller; receiving audio Bluetooth information which is automatically transmitted by the main controller; and pairing and connecting the audio Bluetooth automatically basing on the audio Bluetooth information. The audio Bluetooth pairing and connecting method provided by the present disclosure is capable of saving the complicated operations for connecting the audio Bluetooth, and avoids the cases of misconnection, which realizes quick and reliable pairing of audio Bluetooth. A device and a system for audio Bluetooth pairing and connecting are also provided.

### CROSS REFERENCE TO RELATED APPLICATIONS

This application claims priority to Chinese Patent Application No. 201611264335.X, filed Dec. 31, 2016, which is hereby incorporated by reference herein as if set forth in its entirety.

### BACKGROUND

### 1. Technical Field

The present disclosure generally relates to wireless connection, and particularly to a method, device and system for audio Bluetooth pairing and connecting.

### 2. Description of Related Art

In the existing audio Bluetooth connecting methods, a phone Bluetooth has to be opened first, then Bluetooth signals are searched, a corresponding audio Bluetooth module name is manually clicked, and the Bluetooth can be connected at the pairing is confirmed. In the case with more Bluetooth devices, it is difficult to find the name of the Bluetooth to be connected, and the connection operations are relatively complex.

### BRIEF DESCRIPTION OF THE DRAWINGS

FIG. 1 is a flow chart of an audio Bluetooth pairing and connecting method according to an embodiment of the present disclosure.

FIG. 2 is a flow chart of an audio Bluetooth pairing and connecting method according to another embodiment of the present disclosure.

FIG. 3 is a flow chart of an audio Bluetooth pairing and connecting method according to a further embodiment of the present disclosure.

FIG. 4 is a block diagram of an audio Bluetooth pairing and connecting device according to an embodiment of the present disclosure.

FIG. 5 is a schematic diagram of an audio Bluetooth pairing and connecting system according to an embodiment of the present disclosure.

FIG. 6 is a schematic diagram of an audio Bluetooth pairing and connecting method according to a still further embodiment of the present disclosure.

### DETAILED DESCRIPTION

In order that the objects, technical solutions and advantages of the present disclosure can be more clearly understood, the present disclosure will be described in more detail with reference to the accompanying drawings and embodiments. It is to be understood that the described embodiments are merely for explaining the present disclosure, not for limiting the present disclosure.

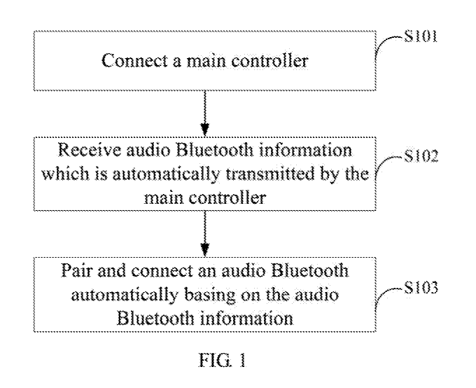

As shown in FIG. 1, an audio Bluetooth pairing and connecting method according to an embodiment of the present disclosure includes the following steps:

S101: connecting a main controller.

Specifically, a mobile device is connected with the main controller of a robot via Bluetooth. The mobile device can be a cell phone. The main controller inquires whether a system of the robot includes an audio Bluetooth. If the system includes the audio Bluetooth, the main controller obtains audio Bluetooth information.

S102: receiving the audio Bluetooth information which is automatically transmitted by the main controller.

Specifically, the mobile device receives the audio Bluetooth information which the main controller automatically transmits.

Preferably, the audio Bluetooth information includes a name and MAC address information of the audio Bluetooth. Through the name and the MAC address information of the audio Bluetooth, the audio Bluetooth to be paired can be identified and connected more quickly.

S103: pairing and connecting the audio Bluetooth automatically basing on the audio Bluetooth information.

Specifically, after the mobile device receives the connection information of the audio Bluetooth, the audio Bluetooth is paired automatically basing on the name and the MAC address information of the audio Bluetooth.

In the embodiment, the mobile device communicates with the robot via a main Bluetooth which transmits large amount of data to control movement of the robot. Audio data might be transmitted by another Bluetooth, i.e., audio Bluetooth. The audio Bluetooth pairing and connecting method provided by this embodiment is capable of saving the complicated operations for connecting the audio Bluetooth, especially for the complicated operations of the first connection, and avoids the cases of misconnection, which provides the reliability of connection.

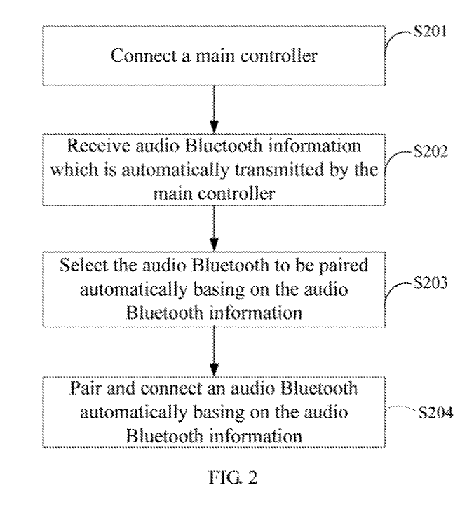

As shown in FIG. 2, an audio Bluetooth pairing and connecting method according to another embodiment of the present disclosure includes the following steps:

S201: connecting a main controller.

S202: receiving audio Bluetooth information which is automatically transmitted by the main controller.

S203: selecting the audio Bluetooth to be paired automatically basing on the audio Bluetooth information.

Specifically, the robot includes a plurality of audio Bluetooth devices, the main controller of the robot transmits all the audio Bluetooth information automatically, and a user needs to select the audio Bluetooth to be paired on the mobile device.

S204: pairing and connecting the audio Bluetooth automatically basing on the audio Bluetooth information.

The above-mentioned steps S201, S202, and S204 are the same as the steps S101-S103 in the previous embodiment, and will not be described again.

The audio Bluetooth pairing and connecting method provided by this embodiment is capable of saving the complicated operations for connecting the audio Bluetooth, and avoids the cases of misconnection, which provides the reliability of connection.

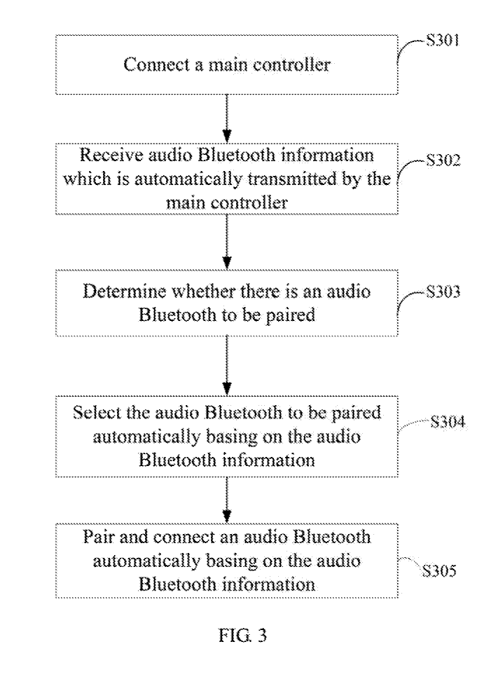

As shown in FIG. 3, an audio Bluetooth pairing and connecting method according to a further embodiment of the present disclosure includes the following steps:

S301: connecting a main controller.

S302: receiving an audio Bluetooth information which is automatically transmitted by the main controller.

S303: determining whether there is an audio Bluetooth to be paired;

do not pairing and connecting if there is no audio Bluetooth to be paired;

executing step S304 to select the audio Bluetooth to be paired if there is an audio Bluetooth to be paired.

Specifically, the mobile device receives the audio Bluetooth information. If there is no audio Bluetooth to be paired, the connection is not performed, returns directly, and the connection operation is ended. If there is an audio Bluetooth to be paired, the steps S304 and S305 are executed.

Step S304: selecting the audio Bluetooth to be paired (automatically) basing on the audio Bluetooth information.

Step S305: pairing (and connecting) the audio Bluetooth (automatically) basing on the audio Bluetooth information.

The above-mentioned steps S301, S302, S304, and S305 are the same as the steps S201, S202, S203, and S204 in the previous embodiment, and will not be described again.

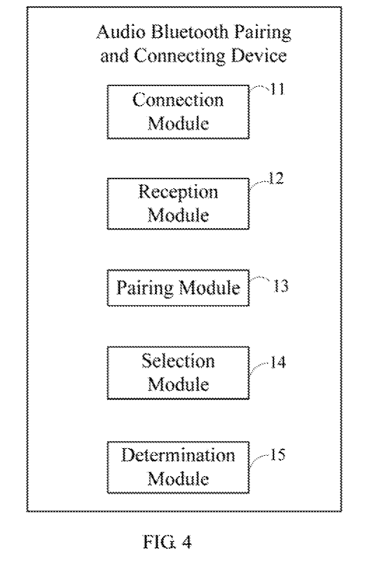

Furthermore, the present disclosure also provides an audio Bluetooth pairing and connecting device. As shown in FIG. 4, the audio Bluetooth pairing and connecting device includes a connection module 11, a reception module 12, and a pairing module 13. The device can include processor(s) (e.g. central processing unit (CPU)) and storage device(s) (e.g., random-access memory (RAM)). The storage device(s) store a plurality of instructions (or the above-mentioned modules). When executed by the processor(s), the instructions cause the processor(s) to perform the functions in the above-mentioned modules.

The connection module 11 is configured to connect a main controller.

The reception module 12 is configured to receive audio Bluetooth information which is automatically transmitted by the main controller.

The pairing module 13 is configured to pair and connect the audio Bluetooth automatically basing on the audio Bluetooth information.

Preferably, the audio Bluetooth pairing and connecting device further includes a selection module 14.

The selection module 14 is configured to select the audio Bluetooth to be paired automatically basing on the audio Bluetooth information.

Preferably, the audio Bluetooth pairing and connecting device further includes a determination module 15.

The determination module 15 is configured to determine whether there is an audio Bluetooth to be paired;

not pair and connect the audio Bluetooth if there is no audio Bluetooth to be paired; and

select the audio Bluetooth to be paired automatically basing on the audio Bluetooth information if there is an audio Bluetooth to be paired.

Preferably, the audio Bluetooth information includes a name and MAC address information of the audio Bluetooth.

The device in this embodiment and the method in the above-mentioned embodiment are based on two aspects under the same inventive concept, and the implementation process of the method has been described in detail. Hence, those skilled in the art can clearly understand the structure and the implementation process of the device in this embodiment basing on the foregoing description, which are not described here for the sake of the simplicity of the specification.

For the sake of the convenience of description, the above device is described in various modules which are divided based on functionalities. Of course, the functionality of each module can be implemented in the same or various softwares and/or hardwares when implementing the present disclosure.

As will be understood from the description of the above embodiments, it will be apparent to those skilled in the art that the present disclosure can be realized by means of software plus a common hardware platform. Based on this understanding, the entirety or a portion of the technical solution of the present disclosure can be embodied in the form sofa software product. The software product can be stored in a storage medium such as ROM, RAM, diskette, compact disk, etc., which includes a plurality of instructions for enabling a computer device (can be a personal computer, a server, or a network device, etc.) to execute the methods described in each embodiment or certain portion(s) of an embodiment of the present disclosure.

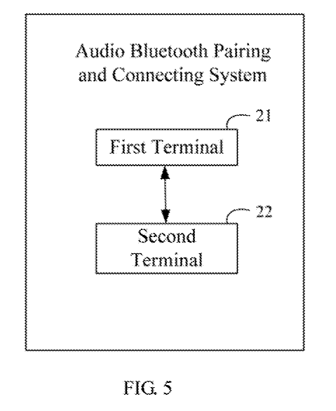

Still furthermore, the present disclosure also provides an audio Bluetooth pairing and connecting system. As shown in FIG. 5, the audio Bluetooth pairing and connecting system includes a first terminal (device) 21 and a second terminal (device) 22 including a main controller.

The first terminal 21 is configured to connect the main controller of the second terminal 22.

The second terminal 22 includes the main controller configured to (automatically) transmit audio Bluetooth information.

The first terminal 21 is further configured to receive the audio Bluetooth information automatically transmitted by the main controller of the second terminal 22 as well as pair and connect the audio Bluetooth automatically basing on the audio Bluetooth information.

The system in this embodiment and the method in the above-mentioned embodiment are based on two aspects under the same inventive concept, and the implementation process of the method has been described in detail. Hence, those skilled in the art can clearly understand the structure and the implementation process of the system in this embodiment basing on the foregoing description, which are not described here for the sake of the simplicity of the specification.

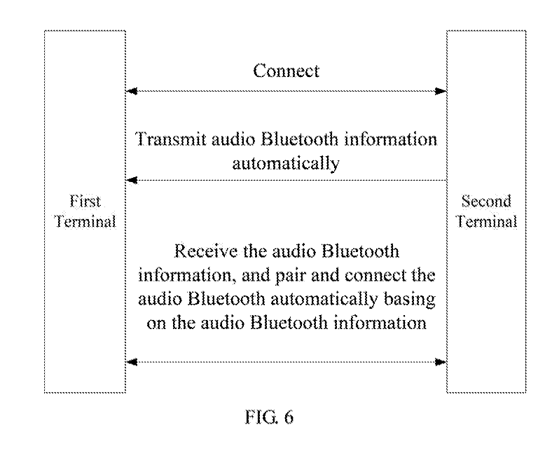

In addition, the present disclosure provides a still further audio Bluetooth pairing and connecting method. As shown in FIG. 6, the audio Bluetooth pairing and connecting method includes the following steps:

connecting as first terminal with a main controller of a second terminal;

transmitting audio Bluetooth information (automatically) through the main controller of the second terminal; and

receiving the audio Bluetooth information which is automatically transmitted by the main controller of the second terminal as well as pairing and connecting the audio Bluetooth automatically basing on the audio Bluetooth information through the first terminal.

The method in this embodiment and the system in the above-mentioned embodiment are based on two aspects under the same inventive concept, and the system has been described in detail. Hence, those skilled in the art can clearly understand the method in this embodiment basing on the foregoing description, which are not described here for the sake of the simplicity of the specification.

The audio Bluetooth pairing and connecting method, device and system provided by the present disclosure is capable of saving the complicated operations for connecting the audio Bluetooth, and avoids the cases of misconnection which realizes quick and reliable pairing of audio Bluetooth.

It will be apparent to those skilled in the art that various other corresponding changes and modifications can be made in accordance with the technical solutions and concepts described above, and that all such changes and modifications are intended to be within the scope of the protection of the present disclosure.

What is claimed is:

1. An audio Bluetooth pairing and connecting method, comprising:
connecting a main controller;
receiving audio Bluetooth information being automatically transmitted by the main controller; and
pairing and connecting an audio Bluetooth automatically basing on the audio Bluetooth information.

2. The method of claim 1, wherein before the pairing and connecting the audio Bluetooth automatically basing on the audio Bluetooth information further comprises:
selecting the audio Bluetooth to be paired automatically basing on the audio Bluetooth information.

3. The method of claim 2, wherein before the pairing and connecting the audio Bluetooth automatically basing on the audio Bluetooth information further comprises:
determining whether there is an audio Bluetooth to be paired;
not performing the pairing and connecting if there is no audio Bluetooth to be paired;
performing the selecting the audio Bluetooth to be paired automatically basing on the audio Bluetooth information if there is an audio Bluetooth to be paired.

4. The method of claim 1, wherein the audio Bluetooth information comprises a name and MAC address information of the audio Bluetooth.

5. The method of claim 1, further comprising:
inquiring whether a system includes the audio Bluetooth through the main controller; and
obtaining the audio Bluetooth information through the main controller if the system includes the audio Bluetooth.

6. An audio Bluetooth pairing and connecting device comprising:
one or more processors; and
one or more storage devices storing a plurality of instructions, wherein when executed by the one or more processors, the instructions cause the one or more processors to:
connect a main controller;
receive audio Bluetooth information being automatically transmitted by the main controller; and
pair and connect an audio Bluetooth automatically basing on the audio Bluetooth information.

7. The device of claim 6, wherein the instructions further cause the one or more processors to:
select the audio Bluetooth to be paired automatically basing on the audio Bluetooth information.

8. The device of claim 7 wherein the instructions further cause the one or more processors to:
determine whether there is an audio Bluetooth to be paired, not pair and connect the audio Bluetooth if there is no audio Bluetooth to be paired, and select the audio Bluetooth to be paired automatically basing on the audio Bluetooth information if there is an audio Bluetooth to be paired.

9. The device of claim 6, wherein the audio Bluetooth information comprises a name and MAC address information of the audio Bluetooth.

10. The device of claim 6, wherein the instructions further cause the one or more processors to:
inquire whether a system includes the audio Bluetooth through the main controller; and
obtain the audio Bluetooth information through the main controller if the system includes the audio Bluetooth.

11. An audio Bluetooth pairing and connecting system comprising a first terminal and second terminal, wherein:
the second terminal comprises a main controller configured to automatically transmit audio Bluetooth information;
the first terminal is configured to connect the main controller of the second terminal; and
the first terminal is further configured to receive the audio Bluetooth information automatically transmitted by the main controller of the second terminal as well as pair and connect the audio Bluetooth automatically basing on the audio Bluetooth information.
